(19) United States
(12) Patent Application Publication
(10) Pub. No.: US 2014/0365930 A1
(43) Pub. Date: Dec. 11, 2014

(54) REMOTE DISPLAY OF CONTENT ELEMENTS

(71) Applicant: Hewlett-Packard Development Company, L.P., Houston, TX (US)

(72) Inventors: Christopher Willis, Palo Alto, CA (US); Kevin Smathers, Hayward, CA (US); Henry Sang, JR., Cupertino, CA (US)

(21) Appl. No.: 13/914,333

(22) Filed: Jun. 10, 2013

(51) Int. Cl. G06F 3/0484

(52) U.S. Cl. CPC G06F 3/0484
USPC 715/766

(57) ABSTRACT

A system and method for creating a caching system for remote display of content elements are described herein. In one example, a method can include loading a first content element in a remote display system and a second content element in a virtual display. The method can also include detecting a selection of the second content element in a remote interface associated with the virtual display. Additionally, the method can include generating an instruction to move the second content element from the virtual display to the remote display system. Furthermore, the method can include moving the second content element from the virtual display to the remote display system. In addition, the method can include displaying the first content element and the second content element without overlapping in the remote display system.

### BACKGROUND

In many control rooms and operation centers, a control system can manage and display information across a number of computing devices. In some examples, each computing device can be connected to a separate display device that can display various aspects of processes or complex industrial systems. For example, a control system may manage industrial processes by monitoring information from a number of programmable logic controllers and displaying the information using an application or system such as a supervisory control and data acquisition (also referred to herein as SCADA) system or a distributed control system (also referred to herein as DCS).

### BRIEF DESCRIPTION

Certain examples are described in the following detailed description and in reference to the drawings, in which:

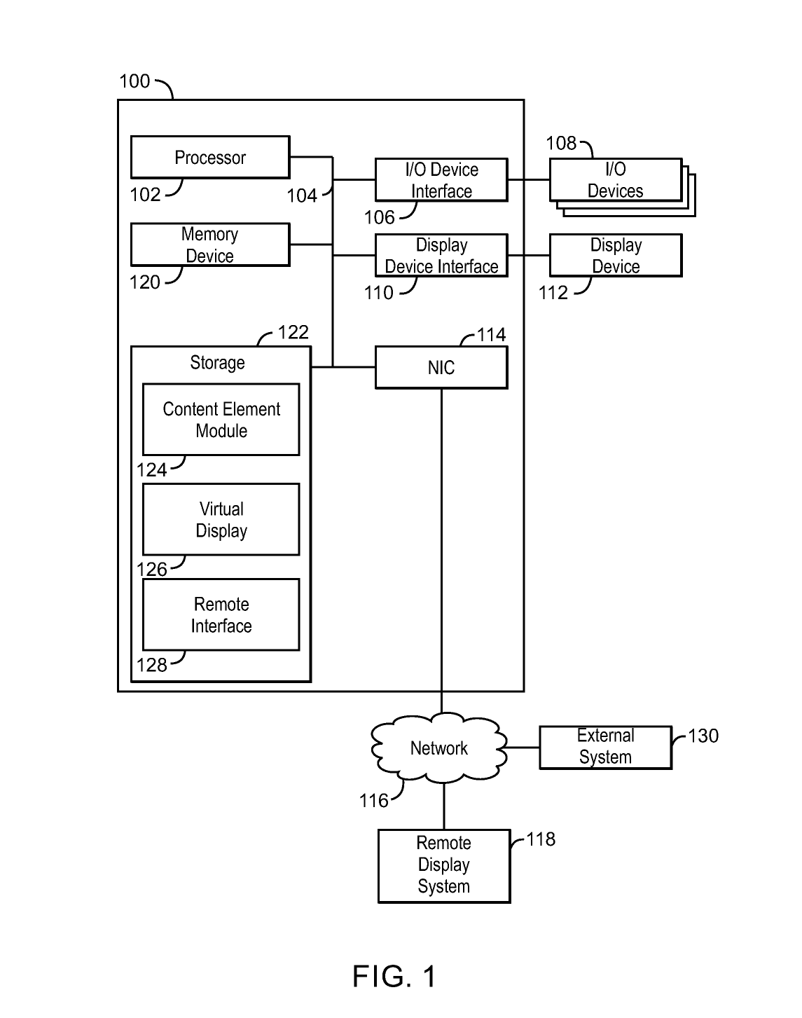

FIG. 1 is a block diagram of an example computing system that can manage content elements;

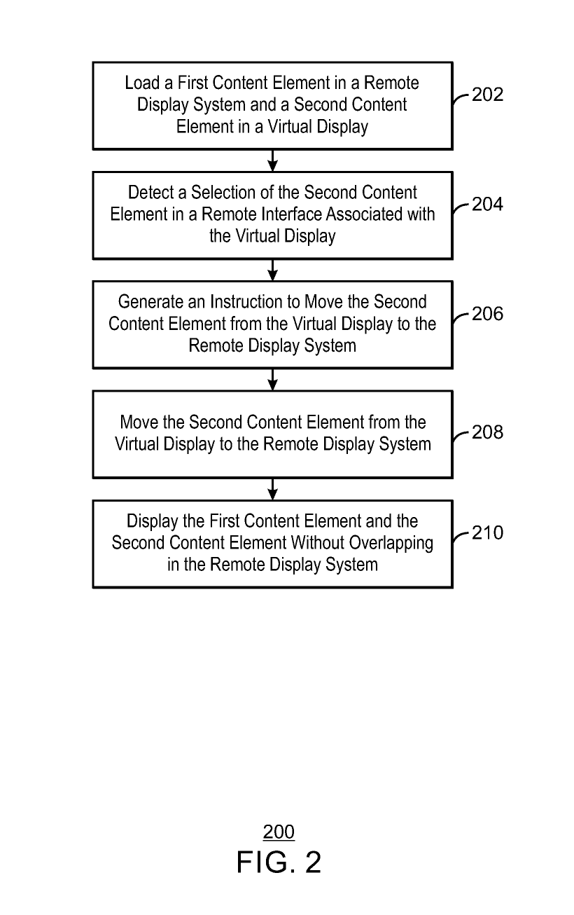

FIG. 2 is a process flow diagram of an example method that can manage content elements;

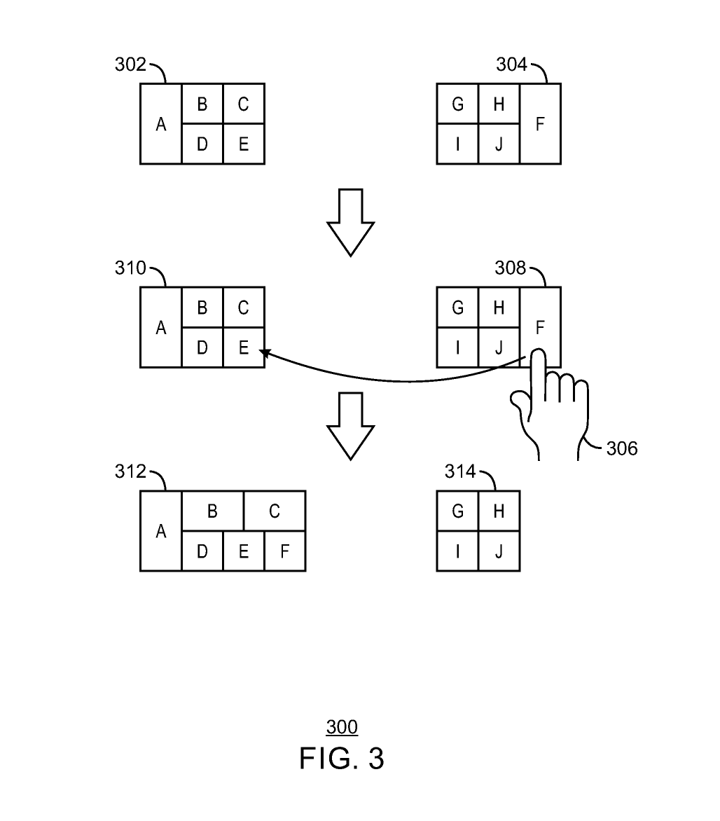

FIG. 3 is an example of a graphical user interface that manages content elements;

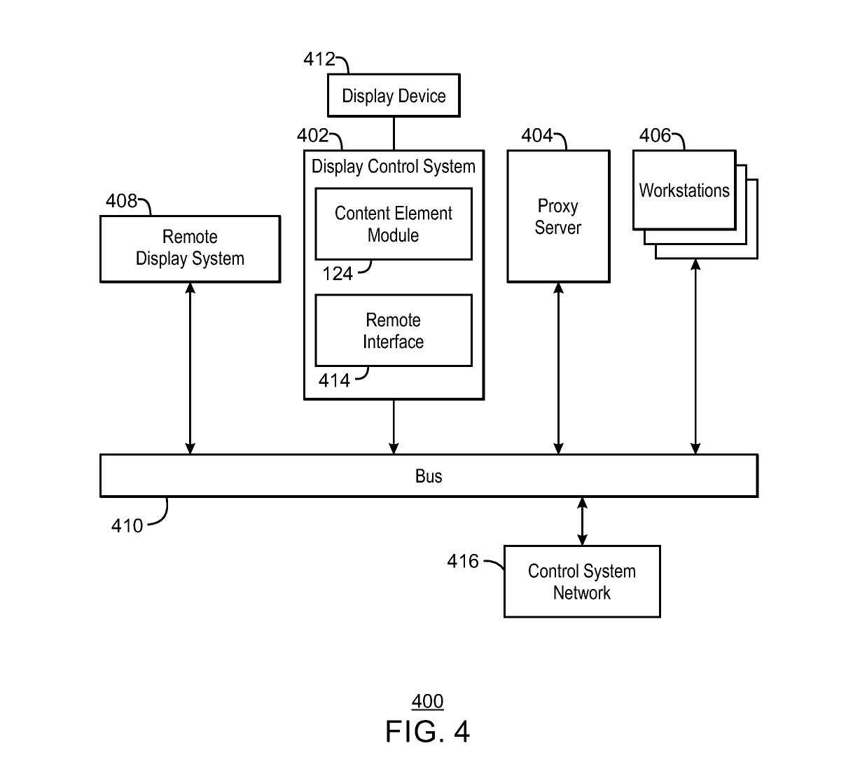

FIG. 4 is a block diagram of example systems that can manage content elements;

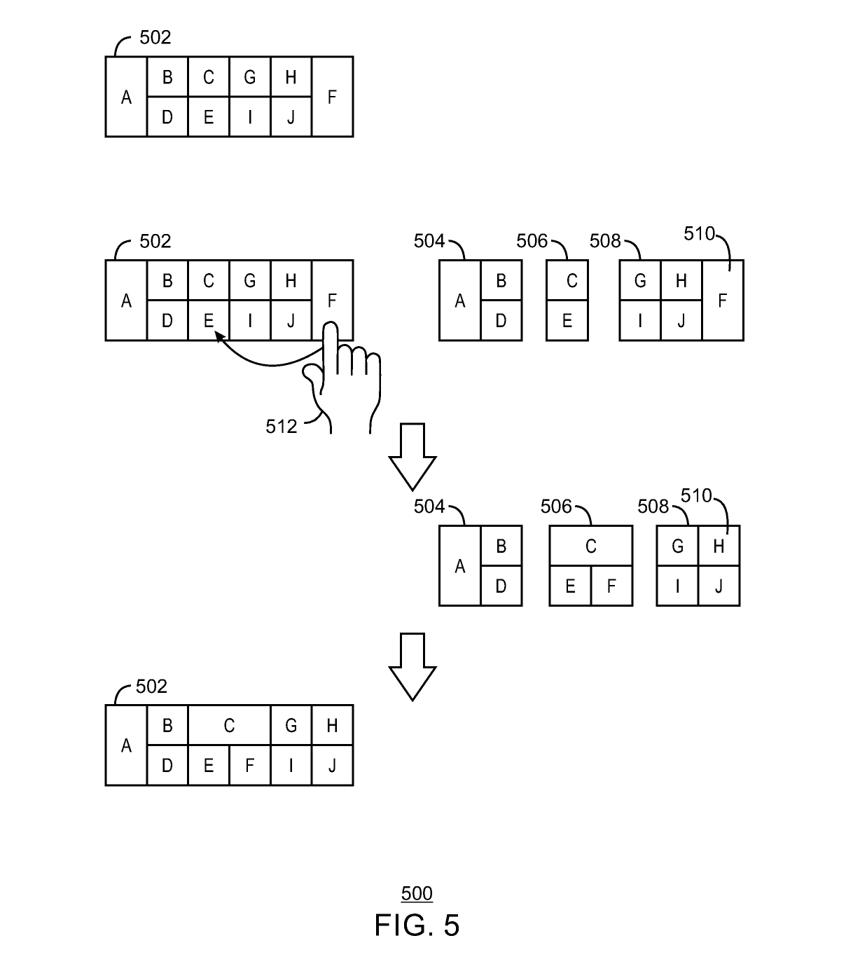

FIG. 5 is an example of a graphical user interface for a control display that manages content elements; and

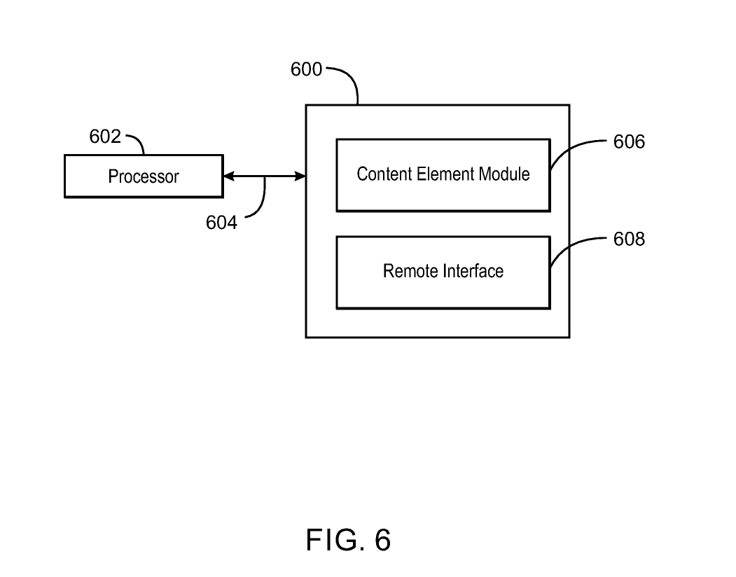

FIG. 6 is a block diagram depicting an example of a tangible, non-transitory computer-readable medium that can manage content elements.

### DESCRIPTION OF THE EXAMPLES

Many control systems use custom software to display information about various processes. In current systems, the custom display software is not reconfigurable, e.g., the information that will be displayed is determined at the time the control software is initially configured. Thus, to reconfigure the control software to add or remove information from a display device, the custom software is modified and redeployed. Thus, the custom software is often limited to display information in a real time database embedded in a system.

According to examples of the subject matter described herein, content elements can be displayed in a remote display system and loaded in a virtual display. A content element, as referred to herein, can include web based data, ActiveX® based data, application based data, process control data (such as sensor readings), digital images, digital video, remote desktop login data, and office documents, among others. A remote display system, as referred to herein, can include any suitable number of display devices connected to any suitable number of computing devices. In some examples, a display device used with the system can be a multi-projector or multi-remote display system covering an entire wall and may display any suitable number of content elements.

A virtual display, as referred to herein, can pre-load any suitable number of content elements that are not to be displayed in a remote display system. In one example, the term virtual display includes a reserved section of the main memory of a computer system that can store data or content elements that is not accessible by a graphics processor. The computer system may also include a remote display system that includes memory that is accessible by both a central processing unit and by a graphics processor. The content elements in the memory of the remote display system can be written by the CPU and displayed on a display device by the graphics processor. In this example, the virtual display enables users to pre-load content elements into the section of the main memory where the elements are stored but not displayed. The pre-loaded content elements may then be moved to the memory in the display device on demand. This enables a user to have access to additional content elements through the virtual display and the remote display system. To move a content element from a virtual display to a remote display system, the content elements stored in the virtual display can be loaded into the remote display system in response to the selection of an icon mapped to the virtual display. In some examples, the icon can be viewed through the remote display system.

In some examples, a segment of a memory that is accessible by a graphics processor may not be used for display. This segment of memory can be considered to be a virtual or hidden display. Content elements that are written into this segment of memory are not shown by the graphics processor until desired. For example, upon the selection of an icon mapped to the virtual display, the graphics processor can shift the mapping of the memory to access the content elements in the virtual display.

In some examples, the computing device can also include a set of gestures for controlling the content elements that are displayed in the remote display system and loaded into the virtual display. For example, the set of gestures may enable rearrangement of content elements in the remote display system, moving a content element from a virtual display to the remote display system, and moving a content element from the remote display system to the virtual display, among others. In some examples, the computing device can also include a content element module that can arrange the content elements so that the content elements can be displayed without overlap in the remote display system.

FIG. 1 is a block diagram of an example computing system that can manage content elements. The computing system 100 may include, for example, a server computer, a mobile phone, laptop computer, desktop computer, or tablet computer, among others. The computing system 100 may include a processor 102 that is adapted to execute stored instructions. The processor 102 can be a single core processor, a multi-core processor, a computing cluster, or any number of other appropriate configurations.

The processor 102 may be connected through a system bus 104 (e.g., AMBA®, PCI®, PCI Express®, Hyper Transport®, Serial ATA, among others) to an input/output (I/O) device interface 106 adapted to connect the computing system 100 to one or more I/O devices 108. The I/O devices 108 may include, for example, a keyboard and a pointing device, wherein the pointing device may include a touchpad or a touchscreen, among others. The I/O devices 108 may be built-in components of the computing system 100, or may be devices that are externally connected to the computing system 100.

The processor 102 may also be linked through the system bus 104 to a display device interface 110 adapted to connect the computing system 100 to a display device 112. The display device 112 may include a display screen that is a built-in component of the computing system 100. The display device 112 may also include a computer monitor, television, or projector, among others, that is externally connected to the computing system 100. Additionally, the processor 102 may also be linked through the system bus 104 to a network interface card (NIC) 114. The NIC 114 may be adapted to connect the computing system 100 through the system bus 104 to a network 116. The network 116 may be a wide area network (WAN), local area network (LAN), or the Internet, among others. The network 116 can connect the computing system 100 to a remote display system 118 that can display any suitable number of content elements within any suitable number of display devices.

The processor 102 may also be linked through the system bus 104 to a memory device 120. In some examples, the memory device 120 can include random access memory (e.g., SRAM, DRAM, eDRAM, EDO RAM, DDR RAM, RRAM®, PRAM, among others), read only memory (e.g., Mask ROM, EPROM, EEPROM, among others), non-volatile memory (PCM, STT_MRAM, ReRAM, Memristor), or any other suitable memory systems.

The processor 102 may also be linked through the system bus 104 to a storage device 122. The storage device 122 can include a content element module 124, which can manage the display of content elements. In some examples, the content element module 124 can manage content elements visible through the remote display system 118 and content elements that are loaded into a virtual display 126. In some examples, the storage device 122 can include the virtual display 126, which can store loaded content elements. As discussed above, a content element can include web based data, ActiveX® based data, application based data, process control data (such as sensor readings), images, videos, remote desktop login data, and office documents, among others. In some examples, any number of content elements can be related or share a relationship. For example, a set of content elements may relate to an industrial process, or a set of content elements may share a common characteristic. In some examples, a set of content elements may be visible to any suitable number of users through a remote display system 118. There may be additional content elements that are not visible to users through the remote display system 118. The content element module 124 can load the content elements that are not visible through the remote display system 118 into a virtual display 126. For example, the content element module 124 may determine that a first set of content elements are to be displayed through the remote display system 118 and a second set of content elements are to be loaded into a virtual display 126. In some examples, the virtual display 126 may be viewed through a remote interface 128 from the display device 112. The remote interface 128 may be stored in the storage device 122 as an application that associates icons with content elements stored in the virtual display 126.

In some examples, the content element module 124 can also enable the rearrangement of content elements that are displayed through the remote display system 118 and loaded in the virtual display 126. For example, the content element module 124 can detect a drag and drop operation that indicates a content element in the virtual display 126 is to be moved to the remote display system 118. In some examples, the content element module 124 can rearrange, or modify the aspect ratio of the content elements in the remote display system 118 so that the content element from the virtual display 126 can be viewed without overlap.

In some examples, the content element module 124 can detect data from an external system 130 through the network 116. The external system 130 can include a geographic information system (also referred to herein as GIS), a distributed control system, a direct digital control system, a control circuit such as a programmable logic controller, or a SCADA system, among others. In some examples, the external system 130 can provide process control data related to various sensors, wherein the process control data are to be displayed in a content element. For example, a content element module 124 may detect process control data from an external system 130 and send the process control data to a remote display system 118.

It is to be understood that the block diagram of FIG. 1 is not intended to indicate that the computing system 100 is to include all of the components shown in FIG. 1. Rather, the computing system 100 can include fewer or additional components not illustrated in FIG. 1 (e.g., additional memory devices, video cards, additional network interfaces, etc.). Furthermore, any of the functionalities of the content element module 124 or the remote interface 128 may be partially, or entirely, implemented in any suitable hardware component such as the processor 102. For example, the functionality may be implemented with an application specific integrated circuit, in logic implemented in the processor 102, in a memory device 120, in a video card, or in a co-processor on a peripheral device, among others.

FIG. 2 is a process flow diagram of an example method that can manage content elements. The method 200 can be implemented with any suitable computing device, such as the computing system 100 of FIG. 1. In some examples, the method 200 can create a caching system for the remote display of content elements.

Referring also to FIG. 1, at block 202, the content element module 124 can load a first content element in a remote display system and a second content element in a virtual display. As discussed above, a remote display system can include any suitable number of display devices. For example, a remote display system may include a large wall sized display device, or a number of separate small display devices, or any combination thereof. In some examples, each display device of a remote display system can display any suitable number of content elements. As discussed above, a content element can include process control data (such as sensor readings), web based data, ActiveX® based data, application based data, images, videos, remote desktop login data, and office documents, among others. In some examples, content elements are to be loaded into the virtual display, but not displayed in the remote display system.

At block 204, the content element module 124 can detect a selection of the second content element in a remote interface associated with the virtual display. In some examples, the remote interface can include any suitable number of icons that are associated with content elements loaded in the virtual display. The icons can enable a user to move a content element from a virtual display to a remote display system. In some examples, the second content element can be selected from the remote interface using any suitable input gesture. For example, the content element module 124 may detect that the region of the remote interface that displays the second content element has been touched for a predetermined period of time. In some examples, the second content element can be selected with additional input gestures such as a screen swipe, a mouse click, a drag and drop gesture, or a keyboard stroke, among others. In some examples, the remote interface can be displayed in the remote display system.

At block 206, the content element module 124 can generate an instruction to move the second content element from the virtual display to the remote display system. In some examples, the instruction can include any suitable number of parameters. For example, the instruction can include parameters that indicate a display device that is to display a content element within a remote display system, a filename that includes content that is to be displayed, or any other suitable source for a content element, among others. In some examples, the content element module 124 can generate the instruction in response to a drag and drop input gesture. For example, a drag and drop input gesture may indicate that a content element, such as a file, URL, or image, among others, has been dragged from a remote interface associated with a virtual display and dropped in a remote display system. In some examples, the drag and drop input gesture may also indicate a display device that is to display a dropped content element.

At block 208, the content element module 124 can move the second content element from the virtual display to the remote display system. In some examples, the second content element can be moved from the virtual display to the remote display system in response to a drag and drop instruction. For example, a drag and drop instruction may include a drop target that indicates a content element is to be pasted near a location or near a second content element. In some examples, the content element module 124 can rearrange the content elements displayed in a remote display system each time a new content element is moved or dropped into the remote display system. An example graphical user interface that illustrates moving a content element from a virtual display to a remote display system is described in further detail below in relation to FIG. 3. In some examples, an instruction comprises a notification to the remote display system that the second content element is to be added to the remote display system, and a description of the second content element which is to be written to and read from a shared storage device. In some examples, content elements can be moved from a first remote display system to a second remote display system, from a remote display system to a virtual display, or from a virtual display to a remote display system, among others.

At block 210, the content module 124 can display the first content element and the second content element without overlapping in the remote display system. In some examples, the first content element and the second content element can be displayed together on any suitable number of display devices in the remote display system. For example, each display device in the remote display system may display a different set of content elements. In some examples, the content element module 124 can determine the location to display the first content element and the second content element based on the instruction. For example, as discussed above, the content element module 124 may modify the region of a display device that displays the first content element so the first content element and the second content element can be visible in a display device without overlapping. In some examples, the content element module 124 can determine the modified region of the remote display system to display the first content element based on an aspect ratio of the second content element.

In some examples, the content element module 124 can also determine the orientation of the second content element and the first content element based on the instruction to move the second content element from the virtual display to the remote display system. For example, the instruction can indicate that the second content element is to be displayed in the remote display system proximate the first content element. In some examples, the second element may be displayed to the right or the left of the first content element. The second element may also be displayed above or below the first content element, or in any other suitable orientation to the first content element. In some examples, the second content element or the first content element may also have different aspect ratios. The second content element and the first content element may also be displayed in regions with different geometric shapes or borders. For example, the first content element may be displayed in the remote display system in a circular region, while the second content element may be displayed in the remote display system in a rectangular region.

The process flow diagram of FIG. 2 is not intended to indicate that the operations of the method 200 are to be executed in any particular order, or that all of the operations of the method 200 are to be included in every case. Further, any number of additional steps may be included within the method 200, depending on the specific application.

FIG. 3 is an example of a graphical user interface that manages content elements. The graphical user interface illustrated in FIG. 3 can be generated by any suitable computing device, such as the computing system 100 of FIG. 1. Referring also to FIG. 1, in some examples, a content element module 124 can generate the graphical user interface.

In some examples, the content element module 124 can generate a graphical user interface for a remote display system that includes any suitable number of content elements. For example, the graphical user interface for a remote display system 302 may include content elements A, B, C, D, and E. In some examples, the content element module 124 can also generate a graphical user interface (also referred to herein as a remote interface) for a virtual display 304 that includes any suitable number of icons associated with content elements to be monitored, but not displayed in the remote display system. For example, the graphical user interface for a virtual display 304 can include icons associated with content elements such as G, H, I, J, and F. The icons associated with the content elements displayed in the graphical user interface of the virtual display 304 can enable users to monitor content elements before moving the content elements to the graphical user interface for a remote display system 302.

In some examples, the content element module 124 can detect the selection of a content element in a graphical user interface for a virtual display or a remote display system. For example, a content element displayed in the graphical user interface of the virtual display 304 or remote display system 302 may be selected using any suitable technique. In some examples, the content element module 124 can detect the selection of a content element if a content element is selected with a mouse, a keyboard stroke, or any suitable gesture in a touchpad or touchscreen device. In some examples, the content element module 124 can also detect that the selected content element is to be moved to another graphical user interface. For example, the cursor 306 in the graphical user interface for the virtual display 308 indicates that content element F is selected. The content element module 124 can detect that the cursor 306 indicates the content element F is to be moved to the graphical user interface of the remote display system 310. In some examples, the cursor 306 can indicate that content element F is to be moved so that the content element F is displayed adjacent to content element E in the graphical user interface of the remote display system 310.

In some examples, the content element module 124 can rearrange and modify the aspect ratios of the content elements displayed in a graphical user interface in the remote display system 312 and virtual display 314. For example, the content elements displayed in the remote display system 312 may not overlap. Therefore, the content element module 124 may rearrange or modify the aspect ratios of any suitable number of content elements in the remote display system 312 so that content elements moved from the virtual display 314 to the remote display system 312 are visible. In some examples, the content element module 124 may modify the aspect ratios of content elements in rows or columns of the graphical user interface of the remote display system 312. For example, the content elements displayed in the graphical user interface of the remote display system 312 have a smaller aspect ratio so that the content element F can also be viewed. In some examples, the graphical user interface for a virtual display may not display content elements that have been moved to a remote display system. For example, the graphical user interface of the virtual display 314 includes content elements G, H, I, and J. However, the graphical user interface of the virtual display 314 no longer displays content element F.

It is to be understood that the graphical user interfaces illustrated in FIG. 3 are for illustrative purposes and are not intended to indicate that the graphical user interfaces are to include certain content elements. Rather, the graphical user interface of the remote display system and virtual display can display any suitable number of content elements. Furthermore, the graphical user interface of the remote display system and virtual display can display content elements in any suitable configuration within any suitable number of rows and columns.

FIG. 4 is a block diagram of an example of a networked cluster of systems that can collaboratively manage content elements coordinated over multiple remote display systems. The systems can include a display control system 402, a proxy server 404, workstations 406, and a remote display system 408. In some examples, the display control system 402, the proxy server 404, and any suitable number of workstations 406 can be connected by a bus 410. The bus 410 can include any suitable interconnect fabric that can transmit data. In some examples, the display control system 402, the proxy server 404, and the workstation 406 can include a content element module 124 that manages content elements.

The remote display system 408 can display any suitable number of content elements within any suitable number of display devices. In some examples, the remote display system 408 can receive content elements from a content element module 124 in a display control system 402. The content element module 124 can arrange the location, scale (also referred to herein as zoom), and display area (also referred to herein as aspect ratio) of content elements. In some examples, the content elements displayed in the remote display system 408 may not overlap and each of the content elements may be visible within a display device in the remote display system 408. As discussed above, the content elements can include data from various sources. For example, content elements can include data from sources such as web based content visible through a browser, embeddable ActiveX® controls such as media players for displaying streaming or stored audio or video content, process control data (such as sensor readings), remote desktop sessions, and other applications that provide ActiveX® controls for display, among others. In some examples, the content element module 124 can also include data from any suitable application that includes an automation interface. For example, the content element module 124 may include data from applications such as word processors, which can be embedded in a content element by invoking an automation interface along with an application window capture.

In some examples, the content element module 124 can determine an aspect ratio for any suitable number of content elements, so that each content element is fully displayed without sacrificing the geometric shape of the content elements. For example, the content element module 124 may determine an aspect ratio for each content element, scale each content element, and place successively smaller content elements in the remaining available space of a display device. Alternatively, the content element module 124 may perform a recursive binary search for the aspect ratio of each content element that results in the content elements being visible within a predetermined display aspect ratio.

In some examples, the remote display system 408 can display content elements using a layout. A layout, as referred to herein, can include any suitable arrangement of content elements in any suitable number of rows and columns. In some examples, the layout can be described in a form that includes windows presentation foundation data, form controls, ActiveX® controls, or application windows, among others. The layout can describe the location, aspect ratio, size, and scale of each content element. In some examples, the layout can be converted into a format that can be saved and restored so that layouts can be replaced when switching the configuration of a display device.

In some examples, a display control system 402 can include any suitable number of computing devices that can manage the content elements displayed in the remote display system 408. For example, the display control system 402 may include the content element module 124, which can manage any number of content elements. In some examples, the content element module 124 can detect the selection of a content element from a display device 412. For example, the content element module 124 may detect a “Drag and Drop” instruction, which indicates that a region of a display device 412 has been selected and dropped into a separate display device. In some examples, the Drag and Drop instruction can include a source content element and a destination location in which to display the source content element.

In some examples, the content element module 124 can transmit “Drag and Drop” instructions, among others, to a remote display system 408 using a remote interface 414. In some examples, a remote interface 414 for interacting with the remote display system 408 can enable a user to manage icons associated with a virtual display. In some examples, the remote interface 414 can also enable a user to drag and drop content elements from one remote interface 414 to a remote display system 408, or rearrange content elements within a remote interface 414.

In some examples, the content element module 124 can detect when a content element is moved off the edge of a display device in a remote display system 408 or display control system 402. In response to detecting a content element moved off the edge of a display device, the content element module 124 can generate an edge drop command. The edge drop command can indicate the direction that the content element was moved off of the display device, which can indicate additional display devices that are to display the content element.

In some examples, the workstations 406 can create one or more application windows (also referred to herein as windows) that accept drag and drop requests and forward data to the content element module 124 in the display control system 402. For example, the workstations 406 may have windows that can include any suitable content such as a file from the desktop, or a URL from a web browser, among others. In some examples, the windows can be dragged and dropped in an area at the edge of a display device, or any other suitable location within a display device. The windows can also copy the content to a content element module 124. In some examples, the content element module 124 can create a new content element and send a command to the remote display system 408 indicating that the content element is to be displayed. In some examples, the command can also indicate a location within a display device in the remote display system 408 to display the content element. For example, the command may indicate that the content element is to be displayed proximate related content elements.

In some examples, a control system network 416 can provide process control data through the bus 410 to the display control system 402. The control system network 416 can include a geographic information system, a distributed control system, a direct digital control system, a programmable logic controller, or a SCADA system, among others. In some examples, the control system network 416 can provide data related to various sensors, wherein the data are to be displayed in a content element. For example, a content element module 124 may detect process control data from a control system network 416 and send the process control data to a remote display system 408. In some examples, the display control system 402 may not receive data from a control system network 416. Alternatively, the display control system 402 may detect data to include in content elements from additional networks, or computing devices, among others.

In some examples, the proxy server 404 can include the content element module 124, which can be any suitable web service. The proxy server 404 can provide access to the bus 410, which can be an asynchronous multicast messaging system that delivers a copy of each message including a content element to additional systems in the cluster. In some examples, data related to content elements and layouts can be encapsulated in messages that can be sent from the workstations 406 and the display control system 402 to the remote display system 408 using any suitable internet protocol. For example, the messages can be transmitted using POST or GET requests in any suitable markup language, such as XML, or any suitable standard for data exchange, such as JSON, among others. In some examples, when messages reference files such as images that are located on shared storage devices, the references can be replaced. For example, the references may be replaced with uniform resource locators (also referred to herein as URLs) along with a server interface to the referenced data. In some examples, the application protocol interface can include an initial handshake between a workstation 406 or display control system 402 and the proxy server 404. The proxy server 404 may provide a session identifier in response to the handshake, which can enable the proxy server 404 and the display control system 402 or the workstation 406 to send messages bi-directionally with encoded documents. In some examples, the messages can be encoded in XML documents.

It is to be understood that the block diagram of FIG. 4 is not intended to indicate that the systems illustrated in FIG. 4 are to include all of the components shown in FIG. 4. Rather, systems can include fewer or additional components not illustrated in FIG. 4 (e.g., additional memory devices, video cards, additional network interfaces, etc.).

FIG. 5 is an example of a graphical user interface for a control display that manages content elements. The graphical user interface illustrated in FIG. 5 can be generated by any suitable computing device, such as the computing system 100 of FIG. 1. Referring also to FIG. 1, in some examples, a content element module 124 can generate the graphical user interface.

The content element module 124 can generate a control display 502, which can display content elements in at least two display systems 504 and 506. The control display 502 can also display a remote interface 508, which can include icons 510 associated with content elements loaded into a virtual display. For example, the control display 502 may display content elements A, B, and D from a remote display system 504, content elements C and E from remote display system 506, and icons 510 G, H, I, J, and F from the remote interface 508.

In some examples, the icons 510 in the remote interface 508 can enable a user to move a content element from a virtual display to a remote display system 504 or 506. For example, the control display 502 can detect any suitable user input gesture, such as a drag and drop command, among others. The user input gesture can indicate that a content element loaded into the virtual display is to be moved to a remote display system 504 or 506 with a cursor 512. For example, the icon F in the remote interface 508 may be moved to the remote display system 506. The cursor 512 may indicate that the icon F is to be displayed adjacent the content element E. In some examples, the content element from the virtual display can be moved to two or more remote display systems 504 and 506.

In some examples, the icons 510 displayed in the remote interface 508 may be modified in response to a content element being moved to a remote display system 504 or 506. For example, the icon 510 associated with the moved content element may no longer be displayed in the remote interface 508. The remote interface 508 may then modify the aspect ratios of icons 510 displayed in the remote interface 508. For example, the aspect ratios of icons G, H, I, and J may be larger after the icon F is moved to a remote display system 506. In some examples, the control display 502 can display the modifications to the aspect ratios of content elements in the remote display systems 504 and 506, and the remote interface 508. For example, the control display 502 can display the modified aspect ratios for content elements E, F, G, H, I, and J.

It is to be understood that the graphical user interfaces illustrated in FIG. 5 are for illustrative purposes and are not intended to indicate that the graphical user interfaces are to include certain content elements. Rather, the graphical user interface of the remote display system and virtual display can display any suitable number of content elements. Furthermore, the graphical user interface of the remote display system and virtual display can display content elements in any suitable configuration within any suitable number of rows and columns. In some examples, content elements can also be exchanged between two display devices in a remote display system. For example, a content element from a first remote display system may be exchanged with a content element from a second remote display system.

FIG. 6 is a block diagram depicting an example of a tangible, non-transitory computer-readable medium that can manage content elements. The tangible, non-transitory, computer-readable medium 600 may be accessed by a processor 602 over a computer bus 604. Furthermore, the tangible, non-transitory, computer-readable medium 600 may include computer-executable instructions to direct the processor 602 to perform the steps of the current method.

The various software components discussed herein may be stored on the tangible, non-transitory, computer-readable medium 600, as indicated in FIG. 6. For example, a content element module 606 can manage content elements displayed in a remote display system or loaded into a virtual display. In some examples, the content element module 606 can also rearrange and modify the aspect ratios of the content elements displayed in a remote display system. A remote interface 608 can display icons associated with content elements loaded into a virtual display, which may enable a user to move content elements from a virtual display to a remote display system. It is to be understood that any number of additional software components not shown in FIG. 6 may be included within the tangible, non-transitory, computer-readable medium 600, depending on the specific application.

The present examples may be susceptible to various modifications and alternative forms and have been shown only for illustrative purposes. Furthermore, it is to be understood that the present techniques are not intended to be limited to the particular examples disclosed herein. Indeed, the scope of the appended claims is deemed to include all alternatives, modifications, and equivalents that are apparent to persons skilled in the art to which the disclosed subject matter pertains.

What is claimed is:

1. A method for creating a caching system for remote display of content elements comprising:
loading a first content element in a remote display system and a second content element in a virtual display;
detecting a selection of the second content element in a remote interface associated with the virtual display;
generating an instruction to move the second content element from the virtual display to the remote display system;
moving the second content element from the virtual display to the remote display system; and
displaying the first content element and the second content element without overlapping in the remote display system.

2. The method of claim 1, wherein displaying the first content element and the second content element in the remote display system comprises:
decreasing a size of the first content element to be displayed in the remote display system;
displaying the first content element within the remote display system; and
displaying the second content element adjacent to the first content element in the remote display system.

3. The method of claim 1, comprising:
detecting an input gesture; and
generating the instruction based on the input gesture.

4. The method of claim 1, comprising:
detecting an input gesture to exchange the second content element from the remote display system with a third content element from a second remote display system; and
displaying the third content element in the remote display system and the second content element in the second remote display system.

5. The method of claim 1, comprising receiving process control data to display in the first content element from a control system.

6. The method of claim 5, wherein the control system comprises one of a geographic information system, a distributed control system, a direct digital control system, a control circuit, or a supervisory control and data acquisition system.

7. The method of claim 1, wherein the remote display system comprises a set of display devices and wherein displaying the first content element and the second content element in the remote display system comprises displaying the first content element and the second content element in at least one of the display devices.

8. A system for creating a caching system for remote display of content elements comprising:
a content element module to provide instructions that display content elements; and
a processor configured to execute instructions provided by the content element module, wherein the instructions direct the processor to:
load a first content element in a remote display system and a second content element in a virtual display;
detect a selection of the second content element in a remote interface associated with the virtual display;
generate an instruction to move the second content element from the virtual display to the remote display system;
move the second content element from the virtual display to the remote display system; and
display the first content element and the second content element without overlapping in the remote display system.

9. The system of claim 8, wherein the instructions direct the processor to:
detect a region of the remote display system that displays the first content element;
determine a modified region of the remote display system to display the first content element based on an aspect ratio of the second content element; and
display the first content element within the modified region of the remote display system and the second content element adjacent to the first content element.

10. The system of claim 8, wherein the instructions direct the processor to:
detect an input gesture; and
generate the instruction based on the input gesture.

11. The system of claim 8, wherein the instructions direct the processor to detect an input gesture within the remote interface, wherein the input gesture is detected for a predetermined period of time.

12. The system of claim 8, wherein the generated instruction comprises a notification to the remote display system that the second content element is to be added to the remote display system, and a description of the second content element which is to be written to and read from a shared storage device.

13. The system of claim 8, wherein the instructions direct the processor to receive process control data to display in the first content element from a control system.

14. The system of claim 13, wherein the control system comprises one of a geographic information system, a distributed control system, a direct digital control system, a control circuit, or a supervisory control and data acquisition system.

15. A non-transitory, computer-readable medium comprising a plurality of instructions that, in response to being executed on a computing device, cause the computing device to:
load a first content element in a remote display system and a second content element in a virtual display;
detect a selection of the second content element in a remote interface associated with the virtual display;
generate an instruction to move the second content element from the virtual display to the remote display system;
move the second content element from the virtual display to the remote display system; and
display the first content element and the second content element without overlapping in the remote display system.

16. The non-transitory, computer-readable medium of claim 15, wherein the plurality of instructions, in response to being executed on a computing device, cause the computing device to:
detect a region of the remote display system that displays the first content element;
determine a modified region of the remote display system to display the first content element based on an aspect ratio of the second content element; and
display the first content element within the modified region of the remote display system and the second content element adjacent to the first content element.

17. The non-transitory, computer-readable medium of claim 15, wherein the plurality of instructions, in response to being executed on a computing device, cause the computing device to:
detect an input gesture; and
generate the instruction based on the input gesture.

18. The non-transitory, computer-readable medium of claim 15, wherein the plurality of instructions, in response to being executed on a computing device, cause the computing device to receive process control data to display in the first content element from a control system.

19. The non-transitory, computer-readable medium of claim 18, wherein the control system comprises one of a geographic information system, a distributed control system, a direct digital control system, a control circuit, or a supervisory control and data acquisition system.

20. The non-transitory, computer-readable medium of claim 15, wherein the plurality of instructions, in response to being executed on a computing device, cause the computing device to determine an orientation between the first content element and the second content element.
